(19) United States
(12) Patent Application Publication
(10) Pub. No.: US 2024/0200354 A1
(43) Pub. Date: Jun. 20, 2024

(54) METHOD FOR ERECTING AND/OR DISMANTLING A TOWER, IN PARTICULAR A TOWER OF A WIND POWER INSTALLATION

(71) Applicant: Wobben Properties GmbH, Aurich (DE)

(72) Inventors: Hendrik Lambertus Lagerweij, Kootwijkerbroek (NL); Aart van de Pol, Otterlo (NL); Andre Heinz Pubanz, AMERSFOORT (NL); Albertus Waaijenberg, Barneveld (NL)

(21) Appl. No.: 18/540,637

(22) Filed: Dec. 14, 2023

(30) Foreign Application Priority Data
Dec. 16, 2022 (EP) 22214283.8

(51) Int. Cl. E04H 12/34; B66C 23/20; B66C 23/88; F03D 13/20

(52) U.S. Cl. CPC E04H 12/342; B66C 23/207; B66C 23/88; E04H 12/348; F03D 13/201; F05B 2230/61; F05B 2230/70

(57) ABSTRACT

A method for erecting and/or dismantling a tower, in particular a tower of a wind power installation, comprises providing a climbing crane, erecting the tower by hoisting and fastening tower segments and/or dismantling the tower by detaching and lowering tower segments, implementing, preferably temporary, securing measures for securing the tower in the state of assembly, in particular in the case of expected wind loads on the tower, which comprises taking into consideration the climbing crane, in particular its weight, in implementing the securing measures.

### BACKGROUND

### Technical Field

Embodiments of the invention relate to a method for erecting and/or dismantling a tower, in particular a tower of a wind power installation.

### Description of the Related Art

Erecting and/or dismantling a tower, in particular a tower of a wind power installation, is a complex process that is associated with a high level of cost and time expenditure, as well as a large space requirement. In addition, a particular challenge is that the tower has an altered, in particular lower, load limit during erection and/or dismantling than in the fully erected operating state, in particular in an operating state with an operational nacelle at the top of the tower.

### BRIEF SUMMARY

Some embodiments provide an improved method for erecting and/or dismantling a tower, in particular a tower of a wind power installation. In particular, some embodiments provide a method for erecting and/or dismantling a tower, in particular a tower of a wind power installation, that increases safety during the process of erecting and/or dismantling and/or that reduces the cost and/or time expenditure and/or the space requirement and/or that is a more economical solution.

Some embodiments provide a method for erecting and/or dismantling a tower, in particular a tower of a wind power installation, the method comprising providing a climbing crane, erecting the tower by hoisting and fastening tower segments and/or dismantling the tower by detaching and lowering tower segments, implementing, preferably temporary, securing measures for securing the tower in the state of assembly, in particular in the case of expected wind loads on the tower, which comprises taking into consideration the climbing crane, in particular its weight, in implementing the securing measures.

A climbing crane here denotes a crane that climbs up and/or down the tower to be erected and/or dismantled during the process of erecting and/or dismantling the tower. Climbing cranes are described, for example, in WO 2018/185111 A1, WO 2017/055598 A1 or WO 2017/202841 A1. The solution described here can be used with a multiplicity of climbing crane constructions, in particular with those described in WO 2018/185111 A1, WO 2017/055598 A1 or WO 2017/202841 A1.

The use of a climbing crane has the advantage, inter alia, that there is no need for a stationary crane to be arranged next to the tower to be erected or dismantled. As a result, time and costs are reduced significantly.

When a tower is being erected, securing measures are generally required in order to secure the tower in the state of assembly, in particular if loads on the tower are to be expected. Loads on the tower can result in particular from wind, and depend in particular on the wind velocity. In particular, when the tower is in a state of assembly, if wind velocities occur that reach or exceed a maximum load for the tower in the state of assembly (which may, for example, be significantly different or lower than a maximum load for the tower in the operating state with the nacelle mounted), the tower in the state of assembly may incur damage, which could possibly even result in collapsing of the tower in the state of assembly. Securing measures are therefore generally required when a tower is being erected. Since wind velocities that reach or exceed a maximum load for the tower in the state of assembly usually occur only temporarily, the securing measures are preferably also temporary, i.e. limited in time. In particular, the securing measures are preferably significantly shorter than the total time required to erect the tower.

For example, the securing measures may be implemented, in particular, if the erecting of the tower has to be interrupted due to wind velocities that reach or exceed a maximum load for the tower in the state of assembly. Preferably, the securing measures are terminated again when the expected loads are again below a maximum load for the tower in the state of assembly.

This has the advantage that, even in the event of unfavorable wind conditions occurring while the tower is being erected/dismantled, in which, in the case of existing solutions, the works would otherwise have to be interrupted and/or a crane and/or the tower would have to be completely or partially taken out of operation, the tower can remain in the state of assembly and/or disassembly with the climbing crane without the stability being jeopardized. In particular, it can be advantageous that, even in the event of unfavorable wind conditions, the erecting and/or dismantling can be continued under conditions that would otherwise have resulted in an interruption if existing solutions were used.

Preferably, the securing measures comprise one, two, a number of or all of the following measures:
attaching additional weights, in particular at the top of the tower in the state of assembly,
attaching guys, in particular at the top of the tower in the state of assembly.

Preferably, the terminating of securing measures includes removing additionally attached functional elements, such as additional weights and/or guys.

According to a preferred development, the following further steps are provided in the method: determining a current wind velocity and/or a wind velocity to be expected within the next 72 hours, determining a current load and/or a load to be expected within the next 72 hours on the tower with the climbing crane, on the basis of a current tower height and/or a tower height to be reached within the next 72 hours, and of the determined wind velocity.

In particular, it is envisaged here to determine the current wind velocity and/or the wind velocity expected within the next 72 hours during the erecting and/or dismantling of the tower, and to be able to deduce therefrom the load resulting from the wind flowing around the tower at its current tower height and/or at the tower height to be reached within the next 72 hours.

Wind flowing around the tower can in particular excite the tower to oscillations, which—if they are close to the eigenfrequency of the tower—can become a load that jeopardizes the stability of the tower. This is the case in particular if the tower, while being erected or dismantled, is not yet or no longer in the fully erected operating state, in particular in an operating state with an operational nacelle at the top of the tower, but instead has a lesser tower height and/or there is no nacelle mounted at the top of the tower. In such a state of assembly and/or disassembly, the tower generally has a different eigenfrequency than in the fully erected operating state, in particular in an operating state with an operational nacelle at the top of the tower.

In the development proposed here, the load limit of the tower is influenced positively by the fact that the climbing crane is located on the tower in the state of assembly and/or disassembly. This means that the tower in the state of assembly and/or disassembly without a climbing crane can have a lower load limit than with the climbing crane. In particular, the eigenfrequency of the tower in the state of assembly and/or disassembly can be positively influenced by the arrangement of the climbing crane, in particular in the sense that the eigenfrequency is in a range that is less susceptible to wind excitation. This is due, inter alia, to the fact that the mass of the climbing crane, which is preferably located in each case at the upper end of the tower, acts as a damper on the tower in the state of assembly and/or disassembly.

According to a preferred embodiment, it is provided that the determining of the load comprises: determining an eigenfrequency of the tower, including the climbing crane, on the basis of a current tower height and/or a tower height to be reached within the next 72 hours. As already mentioned, the climbing crane has a particularly positive effect on the eigenfrequency when the tower is in the state of assembly and/or disassembly.

In a further preferred embodiment, it is provided that the determining of the load comprises: determining an excitation resulting from a vortex formation of the tower with wind flowing around it, including the climbing crane, on the basis of a current tower height and/or a tower height to be reached within the next 72 hours. It is preferably provided in this case that the vortex formation is determined as a Kármán vortex street.

In particular, loads caused by vortex formation, such as, in particular, oscillations, can jeopardize the stability of a tower, in particular in the state of assembly and/or disassembly.

This is the case in particular if the separation frequency of the vortices corresponds to the eigenfrequency of the tower around which the flow passes, as this causes the tower to oscillate.

The separation frequency f of the vortices can be determined, in particular according to the Kármán vortex street, using the Strouhal number Sr. The following applies:

$$f = \text{?} \cdot \frac{υ}{d} \text{?}$$

$$\text{?} \text{indicates text missing or illegible when filed}$$

where v is the flow velocity and d is a characteristic dimension of the body around which the flow passes. The Strouhal number is dependent on the shape of the body and the Reynolds number. For cylindrical bodies, it is 0.18-0.22 for a wide range of Reynolds numbers. Here, Sr=0.2 is selected. Here, the diameter is used as the characteristic dimension.

It is therefore advantageous to determine these loads, as here too the load limit of the tower, in particular in the state of assembly and/or disassembly, is positively influenced by the climbing crane.

A further preferred development is characterized by comparing the determined load with a maximum load.

The maximum load is preferably a load limit of the tower in the state of assembly and/or disassembly, in particular at the current tower height and/or the tower height to be reached within the next 72 hours. In particular, the maximum load may also take into consideration the eigenfrequency of the tower, including the climbing crane, in the state of assembly and/or disassembly at the current tower height and/or the tower height to be reached within the next 72 hours.

Also preferred is an embodiment that is characterized by continuing the erecting and/or dismantling of the tower if the determined load does not reach or exceed the maximum load.

This enhancement is advantageous, as here the method can be continued even in the case of unfavorable wind conditions, in which the process of erecting and/or dismantling would have to be interrupted if existing solutions were used.

A further preferred development is characterized by interrupting the erecting and/or dismantling of the tower if the determined load reaches or exceeds the maximum load. An interruption may become necessary, but is generally much less frequent than is the case with the prior art.

Also preferred is an embodiment that is characterized by altering the planned erecting and/or dismantling of the tower, in particular delaying or accelerating it, in such a way that the determined load, in particular the determined load to be expected within the next 72 hours, does not reach or exceed the maximum load.

In this way, for example by adjusting the tower height to be reached within the next 72 hours, the eigenfrequency of the tower with the climbing crane can be altered so that a load limit is not reached or exceeded.

A further preferred embodiment is characterized by the fact that the climbing crane is arranged at the upper end of the current tower height and/or the tower height to be reached within the next 72 hours. Having the climbing crane, and thus the mass associated with the climbing crane, arranged at the upper end of the current tower height and/or the tower height to be reached within the next 72 hours generally has a particularly favorable effect on the eigenfrequency.

Another preferred embodiment may be one in which the height of the position of the climbing crane on the tower is altered upward or downward. In this way also, advantageously, the eigenfrequency of the tower with the climbing crane can be altered so that a load limit is not reached or exceeded.

A further preferred development is characterized by providing a tower stub at the tower base with at least a first tower segment, and preferably with a second tower segment and possibly a third tower segment.

In particular, it is preferred in this case that the first tower segment be provided on a tower foundation.

It is also preferred that the tower stub be erected by means of a mobile crane, for example a truck-mounted crane. Erecting the tower stub preferably comprises hoisting the at least one first tower segment and fastening it to the tower foundation and, if necessary, hoisting the second tower segment and fastening it to the first tower segment and, if necessary, hoisting the third tower segment and fastening it to the second tower segment.

A further preferred development is characterized by fastening the climbing crane to the tower stub.

Providing a tower stub at the base of the tower and fastening the climbing crane to the tower stub is preferably effected to erect the tower, the tower preferably being erected by hoisting further tower segments and fastening the further tower segments to the respective tower segment underneath, and accordingly climbing the climbing crane upward from the tower stub to its full height in the operating state.

A further preferred embodiment is characterized by providing a tower, fastening the climbing crane to the tower, in particular to the top of the tower.

This variant is preferred, in particular, for dismantling the tower. In this case, the climbing crane may preferably be arranged at the top of the tower, in particular at the start of dismantling, at a full height or almost full height of the tower in the operating state. This arrangement at the top of the tower may preferably also be effected in such a way that the climbing crane is first arranged at or near the base of the tower, for example by means of a mobile crane such as, for instance, a truck-mounted crane, and then climbs upward. As soon as the climbing crane is arranged at the top of the tower, dismantling is then preferably effected by detaching and lowering tower segments.

### BRIEF DESCRIPTION OF THE SEVERAL VIEWS OF THE DRAWINGS

Preferred exemplary embodiments are described, as examples, on the basis of the accompanying figures, in which:

FIG. 1 shows a schematic representation of a wind power installation;

FIG. 2 shows a schematic representation of a tower of a wind power installation in the state of assembly, with a climbing crane; and

FIG. 3 shows a schematic flow diagram of an example of the method.

In the figures, elements that are identical or substantially functionally identical are denoted by the same reference designations. General descriptions usually relate to all exemplary embodiments, unless differences are explicitly indicated.

### DETAILED DESCRIPTION

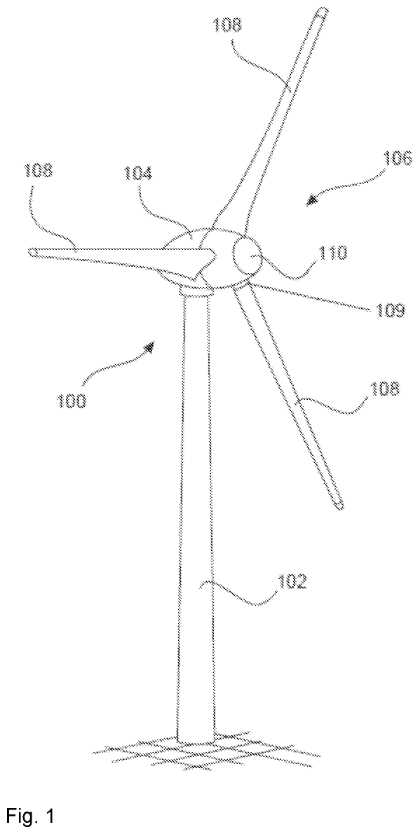

FIG. 1 shows a schematic representation of a wind power installation. The wind power installation 100 has a tower 102, and a nacelle 104 on the tower 102. An acrodynamic rotor 106 that has three rotor blades 108 and a spinner 110 is provided on the nacelle 104. During operation of the wind power installation, the aerodynamic rotor 106 is set in a rotary motion by the wind and thus also rotates an electrodynamic rotor of a generator that is directly or indirectly coupled to the aerodynamic rotor 106. The electric generator is arranged in the nacelle 104 and generates electrical energy. The pitch angles of the rotor blades 108 can be altered by pitch motors at the rotor blade roots 109 of the respective rotor blades 108.

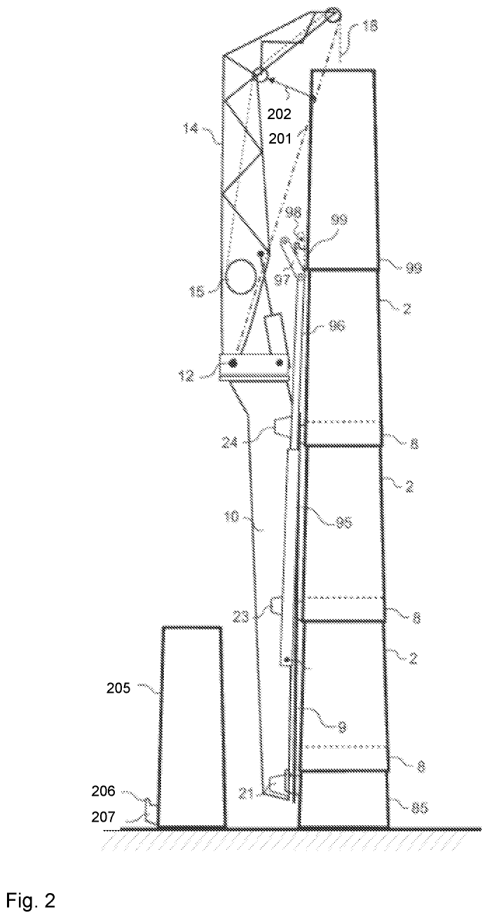

Shown in detail in FIG. 2 is an example of a climbing crane, which may also be referred to as a hoisting system, and an example of first tower segments. The column of the hoisting system comprises a hydraulic cylinder 95 together with a piston 96, and an actuator that is in a state 97 in which it can pass a fastening point 99, and in a state 98 in which it is connected to the fastening point 99. The hoisting system can move upward, once the actuator is in the state 98 and locked to the attachment point 99 on the tower segment 201, and the hydraulic cylinder 95 is actuated, until the weight of the crane is supported by the hydraulic cylinder. Then the locking systems 21, 23 and 24 are unlocked, but it should be noted that, although there are three locking systems represented in FIG. 2, any number of locking systems greater than zero is possible. The hydraulic cylinder 95 is then activated further, such that the piston 96 is drawn into the cylinder 95, causing the hoisting system to move upward. The upward movement continues until any locking system reaches a fixing point at which it can be locked and the weight of the hoisting system can be transferred from the hydraulic cylinder 95 to the locking system.

It should be clear that two cylinders are also possible: each on one side of the column, or even a plurality of cylinders, e.g. cylinders that push the hoisting system upward instead of pulling it upward.

FIG. 2 also shows that, due to the bending of the jib, the jib reaches a distance 202 from the tower segment 201 between the center of the tilt joint and the hoisting point.

Also represented in FIG. 2 is a further tower segment 205 that still needs to be hoisted. The segment has a fastening point 207 having an edge 206 that serves to receive the actuator 98.

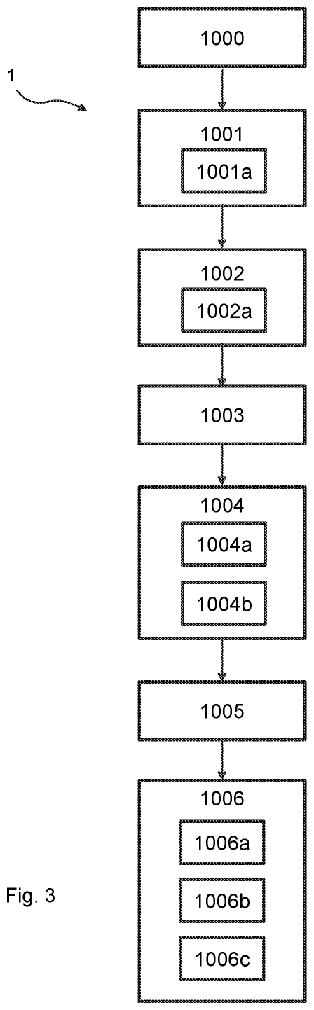

Represented schematically in FIG. 3 is a flow diagram of a method 1 for erecting and/or dismantling a tower, in particular a tower of a wind power installation.

In a first step 1000, a tower stub is provided at the tower base. The tower stub has at least a first tower segment, in particular on a tower foundation, and preferably a second tower segment and possibly a third tower segment, the tower stub preferably being erected by means of a mobile crane, for example a truck-mounted crane.

In a step 1001, a climbing crane is provided, and in the step 1001a it is fastened to the tower stub.

In the step 1002, securing measures are implemented, preferably temporarily, to secure the tower in the state of assembly, in particular if wind loads on the tower are to be expected. In this case, in the step 1002a, the climbing crane, in particular its weight, is taken into consideration. In particular, the securing measures may include attaching additional weights, in particular to the upper end of the tower in the respective state of assembly, and/or attaching guys, in particular to the upper end of the tower in the respective state of assembly. In a step 1003, a current wind velocity and/or a wind velocity to be expected within the next 72 hours is determined.

In a step 1004, a current load and/or a load to be expected within the next 72 hours on the tower with the climbing crane is determined, on the basis of a current tower height and/or a tower height to be reached within the next 72 hours, and of the determined wind velocity. The determining of the load comprises, in a step 1004a, the determining of an eigenfrequency of the tower, including the climbing crane, on the basis of a current tower height and/or a tower height to be reached within the next 72 hours. In a step 1004b, the determining of the load may also comprise the determining of an excitation resulting from a vortex formation of the tower with wind flowing around it, including the climbing crane, on the basis of a current tower height and/or a tower height to be reached within the next 72 hours.

In a step 1005, the determined load is compared with a maximum load.

In a step 1006, the tower is erected by hoisting and fastening tower segments, and/or dismantled by detaching and lowering tower segments.

The erecting and/or dismantling may in particular further comprise a step 1006a with continuing the erecting and/or dismantling of the tower if the determined load does not reach or exceeds the maximum load, and/or a step 1006b with interrupting the erecting and/or dismantling of the tower if the determined load reaches or exceeds the maximum load, and/or a step 1006c with altering the planned erecting and/or dismantling of the tower, in particular delaying or accelerating it, in such a way that the determined load, in particular the determined load to be expected within the next 72 hours, does not reach or exceed the maximum load.

The method described here can be used to create a particularly economical solution for erecting and/or dismantling a tower, in particular a tower of a wind power installation, in which, in particular, the (stability) safety during erecting and/or dismantling is also increased. In addition, advantageously, there are savings of costs and time, and the space requirement is reduced.

European patent application no. 22214283.8, filed Dec. 16, 2022, to which this application claims priority, is hereby incorporated herein by reference in its entirety. Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for erecting and/or dismantling a tower, in particular a tower of a wind power installation, the method comprising:
providing a climbing crane,
erecting the tower by hoisting and fastening tower segments and/or dismantling the tower by detaching and lowering tower segments, and
implementing, preferably temporary, securing measures for securing the tower in the state of assembly, in particular in the case of expected wind loads on the tower, which comprises:
taking into consideration the climbing crane, in particular its weight, in implementing the securing measures.

2. The method as claimed in claim 1, wherein the securing measures comprise one, two or all of the following measures:
attaching additional weights, in particular at the top of the tower in the state of assembly, and
attaching guys, in particular at the top of the tower in the state of assembly.

3. The method as claimed in claim 1, further comprising:
determining a current wind velocity and/or a wind velocity to be expected within the next 72 hours, and
determining a current load and/or a load to be expected within the next 72 hours on the tower with the climbing crane, on the basis of a current tower height and/or a tower height to be reached within the next 72 hours, and of the determined wind velocity.

4. The method as claimed in claim 1, wherein the determining of the load comprises:
determining an eigenfrequency of the tower, including the climbing crane, on the basis of a current tower height and/or a tower height to be reached within the next 72 hours, and/or
determining an excitation resulting from a vortex formation of the tower with wind flowing around it, including the climbing crane, on the basis of a current tower height and/or a tower height to be reached within the next 72 hours.

5. The method as claimed in claim 1, wherein the vortex formation is determined as a Kármán vortex street.

6. The method as claimed in claim 1, further comprising:
comparing the determined load with a maximum load.

7. The method as claimed in claim 1, further comprising:
continuing the erecting and/or dismantling of the tower if the determined load does not reach or exceed the maximum load.

8. The method as claimed in claim 1, further comprising:
interrupting the erecting and/or dismantling of the tower if the determined load reaches or exceeds the maximum load.

9. The method as claimed in claim 1, further comprising:
altering the planned erecting and/or dismantling of the tower, in particular delaying or accelerating it, in such a way that the determined load, in particular the determined load to be expected within the next 72 hours, does not reach or exceed the maximum load.

10. The method as claimed in claim 1, wherein the climbing crane is arranged at the upper end of the current tower height and/or the tower height to be reached within the next 72 hours, and/or the height of the position of the climbing crane on the tower is altered upward or downward.

11. The method as claimed in claim 1, further comprising:
providing a tower stub at the tower base with at least a first tower segment, in particular on a tower foundation, and preferably with a second tower segment and possibly a third tower segment, the tower stub preferably being erected by means of a mobile crane, for example a truck-mounted crane, and
fastening the climbing crane to the tower stub.

12. The method as claimed in claim 1, further comprising:
providing a tower, and
fastening the climbing crane to the tower, in particular to the top of the tower.
